(19) United States
(12) Patent Application Publication
(10) Pub. No.: US 2014/0318661 A1
(43) Pub. Date: Oct. 30, 2014

(54) AIR DUCT

(71) Applicants: Hon Hai Precision Industry Co., Ltd., New Taipei (TW); Hong Fu Jin Precision Industry (ShenZhen) Co., Ltd, Shenzhen (CN)

(72) Inventor: XIAO-FENG MA, Shenzhen (CN)

(21) Appl. No.: 13/928,154

(22) Filed: Jun. 26, 2013

(30) Foreign Application Priority Data
Apr. 29, 2013 (CN) 2013101550324

(51) Int. Cl. F16L 11/14

(52) U.S. Cl. CPC F16L 11/14
USPC 138/128

(57) ABSTRACT

An air duct includes a top wall, a first sidewall, a second sidewall, a first connecting member, and a second connecting member. The first and second connecting members are made of resilient materials. The top wall is connected between the first and second connecting members. The first sidewall is connected to the first connecting member; and the second sidewall is connected to the second connecting member. The first and second connecting members are capable of being pliable to move the first and second sidewalls relative to each other.

### BACKGROUND

1. Technical Field

The present disclosure relates to an air duct.

2. Description of Related Art

Many air ducts are integrally formed. As a result, when situations, such as a number or positions of electronic elements on motherboards are changed, a new air duct may be needed, which increases cost.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of an air duct.

FIG. 2 is an enlarged view of the circled portion II of FIG. 1.

FIG. 3 is an assembled, isometric view of FIG. 1.

FIG. 4 is a partly enlarged, plan view of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

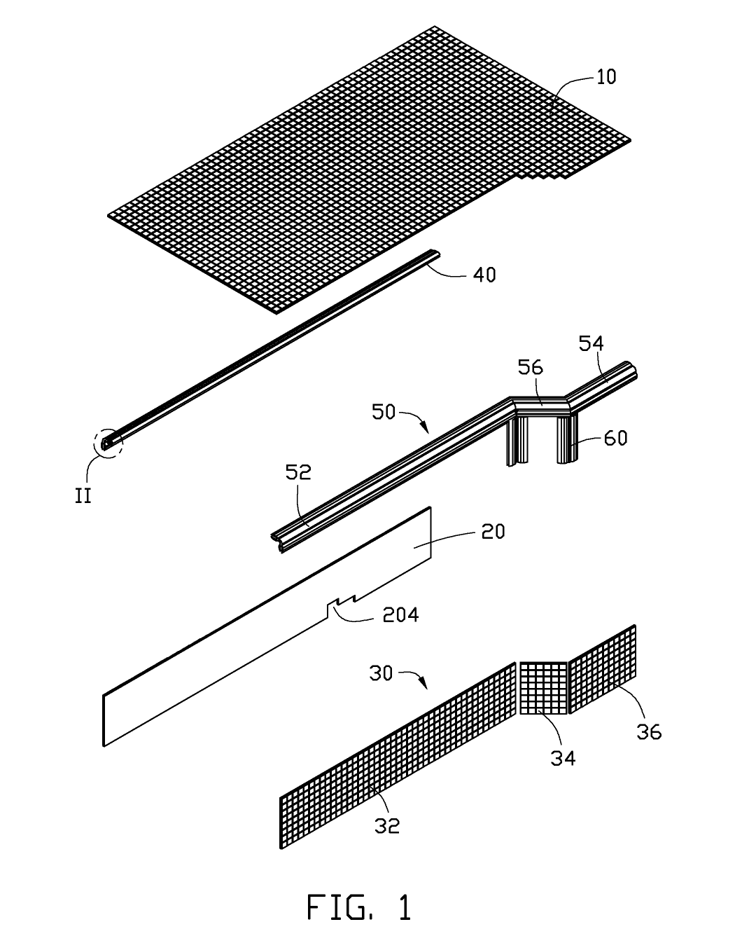

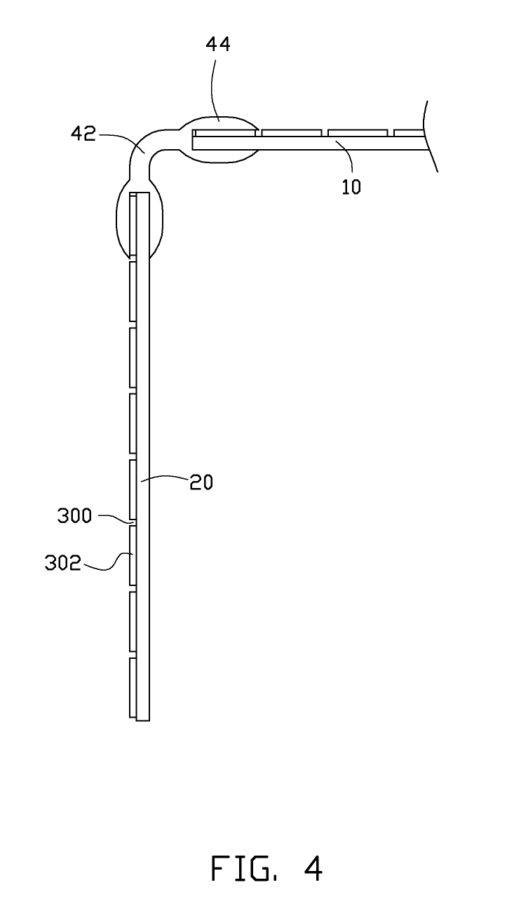

FIGS. 1 and 4 show an embodiment of an air duct. The air duct includes a top wall 10, a first sidewall 20, a second sidewall 30, a first connecting member 40, a second connecting member 50, and two third connecting members 60. All the connecting members are made of resilient materials, such as pliable plastic.

Inner surfaces of the top wall 10 and the first and second sidewalls 20 and 30 are flat surfaces. A plurality of substantially perpendicularly intersected slots 300 is defined in outer surfaces of the top wall 10 and the first and second sidewalls 20 and 30, to divide each of the top wall 10 and the first and second sidewalls 20 and 30 into a plurality of blocking portions 302.

The second sidewall 30 includes a first board 32, a second board 34, and a third board 36.

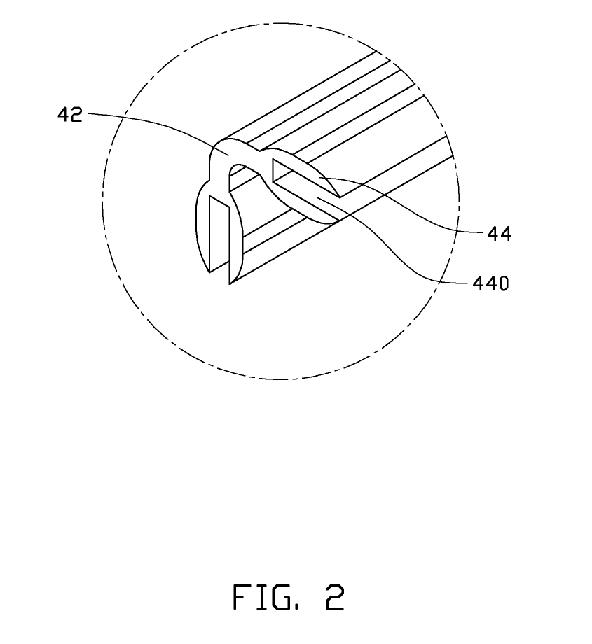

FIG. 2 shows that the first, second, and third connecting members 40, 50, and 60, each include a connecting portion 42 having an L-shaped cross-section, and two clamping portions 44 connected to opposite sides of the connecting portion 42. Each clamping portion 44 defines a receiving slot 440 in a side away from the connecting portion 42. Each receiving slot 440 extends through opposite ends of the corresponding clamping portion 44. The second connecting member 50 includes a first arm 52, a second arm 54 substantially parallel to the first arm 52, and a third arm 56 slantingly connected between the first and the second arms 52 and 54. The third connecting members 60 extending substantially perpendicularly down from junctions of the third arm 56 and the first and second arms 52 and 54.

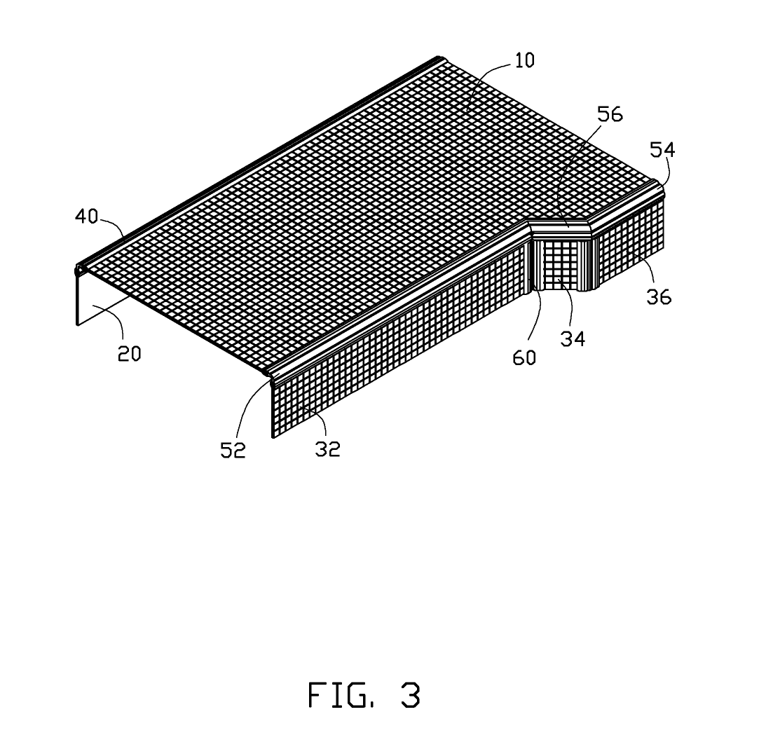

FIGS. 3 and 4 show that in assembly, opposite sides of the top wall 10 are engaged in one of the receiving slots 440 of the first connecting member 40 and one of the receiving slots 440 of the second connecting member 50 away from the third connecting members 60. The first sidewall 20 is engaged in the other receiving slot 44 of the first connecting member 40. The first board 32 is sandwiched between the first arm 52 and the adjacent third connecting member 60, the second board 34 is sandwiched among the third connecting members 60 and the third arm 56, and the third board 36 is connected between the second arm 54 and the adjacent third connecting member 60.

Because the first and second connecting members 40 and 50 are pliable, the first and second sidewalls 20 and 30 can be pivoted about the corresponding connecting portions 42, to change the shape of the air duct.

Since the top wall 10 and the first and second sidewalls 20 and 30 are divided into a plurality of blocking portions 302, some of the blocking portions 302 can be easily removed along the slots 300 to define cutouts 204, thereby allowing air to flow through.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. An air duct, comprising:
a top wall;
a first sidewall;
a second sidewall;
a first connecting member; and
a second connecting member;
wherein the first and second connecting members are made of resilient materials, the top wall is connected between the first and second connecting members, the first sidewall is connected to the first connecting member, the second sidewall is connected to the second connecting member, the first and second connecting members are capable of being pliable to move the first and second sidewall relative to each other.

2. The air duct of claim 1, wherein the top board is detachably connected between the first and second connecting members, and the first and second sidewalls are detachably connected to corresponding first and second connecting members, respectively.

3. The air duct of claim 2, wherein the first and second connecting members each comprises a connecting portion and two clamping portions connected to opposite sides of the connecting portion, each clamping portion defines a receiving slot, and the top wall, the first sidewall, and the second sidewall are correspondingly engaged in the receiving slots.

4. The air duct of claim 3, wherein a cross-section of the connecting portion is L-shaped.

5. The air duct of claim 3, further comprising a third connecting member having a cross-section substantially similar to cross-sections of the first and second connecting members, the second connecting member comprises a first arm and a second arm slantingly connected to the first arm, the third connecting member extends substantially perpendicularly down from a junction of the first and the second arms, the second sidewall comprises a first board connected between the first arm and the third connecting member, and a second board connected between the second arm and the third connecting member.

6. The air duct of claim 1, wherein inner surfaces of the top wall, the first sidewall, and the second sidewall are flat surfaces, a plurality of substantially perpendicularly intersected slots is defined in outer surfaces of the top wall and the first and second sidewalls, to divide each of the top wall and the first and second sidewalls into a plurality of blocking portions.

7. The air duct of claim 6, wherein one or more of the blocking portions is removable to define one or more cutouts in the top wall, and the first and second sidewalls.
